(19) United States
(12) Patent Application Publication
(10) Pub. No.: US 2011/0299613 A1
(43) Pub. Date: Dec. 8, 2011

(54) METHOD AND APPARATUS FOR PROVIDING A BIT MASKED HEARTBEAT SIGNAL

(75) Inventors: Elliot Stanley Duff, Queensland (AU); John David Bunton, New South Wales (AU); Garry Allan Einicke, Queensland (AU); John David Bunton, New South Wales (AU)

(73) Assignee: COMMONWEALTH SCIENTIFIC AND INDUSTRIAL RESEARCH ORGANISATION, Campbell (AU)

(21) Appl. No.: 13/201,528

(22) PCT Filed: Feb. 15, 2010
(86) PCT No.: PCT/AU2010/000155

§ 371 Date: Aug. 15, 2011

(30) Foreign Application Priority Data
Feb. 18, 2009 (AU) 2009900689

(51) Int. Cl. H04L 27/28

(52) U.S. Cl. 375/260

(57) ABSTRACT

An apparatus and method of providing a bit masked heartbeat signal across a digital communication network to a plurality of managed devices, said method comprising the steps of: providing a state value for each one of said managed devices; generating a heartbeat packet comprising state data that incorporates said state value of each one of said managed devices; and transmitting said heartbeat packet to each one of said managed devices.

### FIELD OF THE INVENTION

The present invention relates to communication networks and in particular to digital communication networks.

The invention has been developed primarily for providing a bit masked heartbeat signal across a digital communication network and will be described hereinafter with reference to this application. However, it will be appreciated that the invention is not limited to this particular field of use.

### BACKGROUND OF THE INVENTION

Any discussion of the prior art throughout the specification should in no way be considered as an admission that such prior art is widely known or forms part of the common general knowledge in the field.

Known methods for providing a bit masked heartbeat signal typically relate to safety heartbeat systems that are used in the locomotive industry.

U.S. Pat. No. 7,047,114 discloses a system for automatic and continuous monitoring, proactive warning and control of one or more independently operated vessels. The document proposes that the system provides a modular computer and telecommunications for automatic continuous real-time monitoring, tracking, navigation and proactive warning for one or more marine vessels and for automatically controlling their navigation within a specific region. The system employs intelligent display, GPS, and transceiver/modem devices on marine vessels that are underway, anchored or docked to routinely transmit a vessels ID, GPS and status data to a supervisory fail-safe computer server. The server's resident relational database contains both pre-entered static information about all vessels having similar on-board devices, as well as dynamic information (such as coordinate data relating to rough seas, severe weather, GPS data for all participating vessels, underwater hazards, fog, etc.). Application software in a fail-safe server conducts an ‘around-the-clock’ continuous and automatic real-time comparison of received vessel parameters.

U.S. Pat. No. 6,904,341 discloses an integrated vessel monitoring and control system. Data indicative of operational conditions for vessel systems is transmitted from the vessel to one or more remote sites and commands are received from one or more remote sites for controlling the vessel systems. Multiple transmitting and receiving components are available on the vessel for communicating with a variety of different communications systems at remote sites.

U.S. patent application Ser. No. 11/242,581 (publication number US2007/0207771) discloses a system and method to distribute emergency information. The document proposes that this system and method enables efficient distribution of public warning information using a network infrastructure. These public warning messages are received by a wireless receiver coupled to a network. The wireless receiver broadcasts a message to users on the network responsive to receiving a public warning message.

U.S. patent application Ser. No. 11/029,794 (publication number US2006/0146730) discloses a multicast architecture for wireless mesh networks. The proposed multicast architecture for multi-hop wireless mesh networks is purported to address a problem for wireless mesh networks to efficiently support multicast applications. This architecture enables mesh networks to join global multicast group seamlessly, and extend multicast support to any routable or non-routable devices in wireless mesh networks.

Known systems are typically associated with point-to-point communication, in which a transmitter of a heartbeat signal transmits to each device in turn, or separate channels are required.

### SUMMARY OF THE INVENTION

It is an object of the invention in its preferred form to provide a bit masked heartbeat signal and associated processing apparatus.

In accordance with a first aspect of the present invention, there is provided a method of providing a bit masked heartbeat signal across a digital communication network to a plurality of managed devices, the method comprising the steps of: (a) providing a state value for each one of the managed devices; (b) generating a heartbeat packet comprising state data that incorporates the state value of each one of the managed devices; and (c) transmitting the heartbeat packet to each one of the managed devices.

Preferably, the state value is binary and the state data comprises one bit that is indicative of a respective state value for each one of the managed devices. Alternatively, the state data comprises a plurality of bits indicative of a respective state value for each one of the managed devices. Alternatively, the state data comprises a plurality of bits indicative of a collective state value for two or more of the managed devices. In some embodiments, the communication network comprises a wireless communication network.

Preferably, the method also includes the steps of: (d) receiving the heartbeat packet at a first of the managed devices; (e) isolating, from the state data, a respective state value for the first managed device; and (f) activating, or deactivating, the first managed device in response to the respective state value. Preferably, isolating the state value includes applying a bit mask across a plurality of the state data bits.

In accordance with an alternative aspect of the present invention there is provided a method of processing a bit masked heartbeat packet at a first managed device of a plurality of managed devices, the method comprising the steps of: (a) receiving the heartbeat packet at the first managed device; (b) isolating, from the state data, a respective state value for the first managed device; and (c) activating, or deactivating, the first managed device in response to the respective state value.

The method of the preferred embodiments has particular application when used for air traffic control or naval traffic control and when used for safety management of mining equipment at a mining site.

In accordance with a further aspect of the present invention, there is provided a device for processing a bit masked heartbeat packet at a first managed device of a plurality of managed devices, the device comprising: a receiver for receiving the heartbeat packet via a digital communication network; a processor element coupled to the receiver; the processor adapted to perform the steps of (a) receiving the heartbeat packet at the first managed device; (b) isolating, from the state data, a respective state value for the first managed device; and (c) activating, or deactivating, the first managed device in response to the respective state value.

### BRIEF DESCRIPTION OF THE DRAWINGS

A preferred embodiment of the invention will now be described, by way of example only, with reference to the accompanying drawings in which:

FIG. 1 shows a schematic diagram of an example system for network transmission of heartbeat signal according to the present invention;

FIG. 2 shows a schematic diagram of an example system for encoding and decoding a heartbeat signal;

FIG. 3A shows an example flowchart of a method of generating a heartbeat signal;

FIG. 3B shows an example flowchart of a method of decoding a heartbeat signal; and

FIG. 4 shows an example data packet for use with eight devices.

### PREFERRED EMBODIMENT OF THE INVENTION

In an embodiment, a bit masked heartbeat signal (or message) can be transmitted across a communications network to a multitude of devices. These devices may include, or be incorporated into, machinery. The communications network can be wired or wireless—although it will be appreciated that a wireless network would have a greater application for this invention.

A broadcast heartbeat signal can further include a number of data bits encoded within. By way of example, each bit can correspond to a different device (or machine) in the network. For example, if there are n devices in the network, n bits can be included in the heartbeat signal, where each bit is indicative of keeping a respective pre-designated device enabled (or alive). That is, for the nth device, the nth bit will indicate an intended state in which ‘1’ can indicate keep-active (or keep-alive) and ‘0’ can indicate deactivate (or terminate).

In an embodiment, a device receiving a heartbeat signal will only keep an associated machine “activated” or “alive” if, and only if, a valid heartbeat signal is received (not corrupted or incorrectly encrypted) and a pre-designated bit is appropriately set. In this example, there is no requirement for an acknowledgement to be sent back to the heartbeat-transmitting device, although one can be sent.

In an alternative embodiment, each device (or machine) can have a uniquely identifying bit mask. In this example embodiment, multiple bits are required to keep the device active. It will be appreciated that this approach can be used to build a hierarchy of dependencies across a network, whereby sub-networks can be defined.

An embodiment can provide a system wide heartbeat signal that enables a site operator (including human or computer) to selectively shutdown equipment or to shutdown an entire site.

Heartbeat based safety systems typically comprise either a Point-to-Point or Point-to-Many communication, in which: Point-to-Point: A transmitter and receiver are substantially locked to each other. This is typically used in wireless remote control system, such as those used to control overhead cranes. In this example, a receiver will trip a safety relay if a heartbeat signal is not received from a specific transmitter within a predefined time period. Point-to-Many: A transmitter broadcasts a heartbeat signal to a plurality of receivers. In this example, the heartbeat signal indicates that an entire system is either ‘ON’ or ‘OFF’ (enabled or disabled).

In an embodiment, a single heartbeat signal is generated that includes information that can independently “keep-alive” each machine in the network. In this example, the heartbeat signal can indicate that an entire system can be ‘ON’ or ‘OFF’ (enabled or disabled), and if the system is ON then the heartbeat signal can further indicate that designated devices in the system be enabled or disabled. The heartbeat signal can uniquely identify each of the plurality of receivers.

A single transmitter can be used to transmit an individual heartbeat signal for each device. Although a single transmitter may transmit a heartbeat for device 1, followed by a heartbeat signal for device 2 etc, it would be appreciated that this is less efficient and does not scale very well. For this example, if N devices were to be managed, then N heartbeats signals comprising address, encryption and error recovery information would be sequentially transmitted.

In an embodiment, at predetermined time intervals, only one heartbeat signal is generated and transmitted which contains independent management for a plurality of devices. It will be appreciated that processing overhead for this technique can be significantly lower than independently generating and transmitting a separate heartbeat signal for each of the plurality of devices.

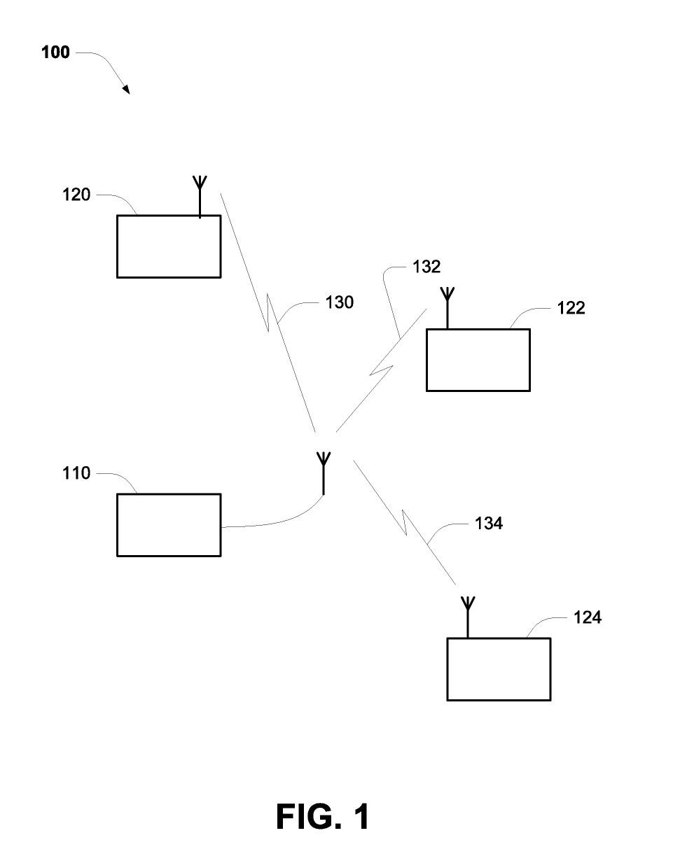

FIG. 1 shows a schematic diagram of an example system 100 for network transmission of heartbeat signal. A control device 110 generates a heartbeat signal at periodic intervals. This heartbeat signal is encoded and transmitted by an antenna to a plurality of devices 120, 122 and 124 (for example a drill rig, truck or excavator) via a respective wireless transmission path 130, 132, and 134. Throughout this site, each device is able to receive the same heartbeat signal.

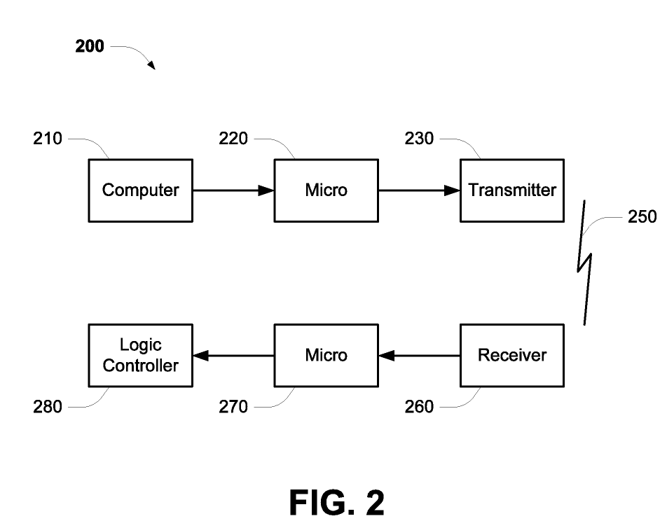

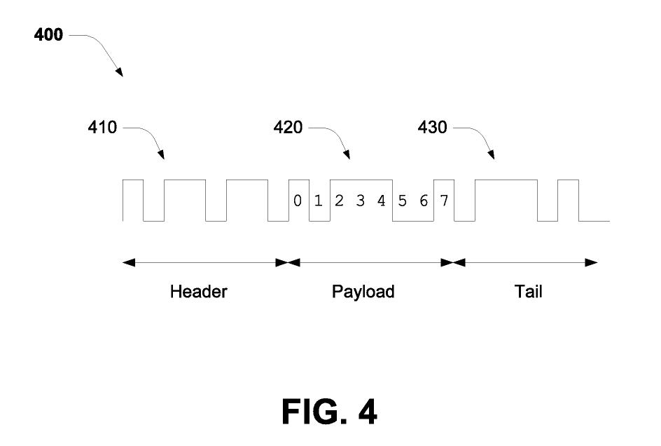

FIG. 2 shows a schematic diagram of an example system for encoding and decoding a heartbeat signal. In this embodiment, a computer 210 has (or is provided) a record of the desired state of each managed device on the site. This state information is converted into a payload of n data bits, where the state of each managed device is incorporated. A microprocessor 220 is used to add a header (for synchronization and security) and a tail (including checksum for data integrity) to build a complete data packet (as best shown in FIG. 4). A transmitter 230 converts this data packet into an RF signal for transmission over a transmission path 250. A receiver 260 receives the heartbeat signal and recovers the data packet. Another microprocessor 270, decodes the incoming data packet, and extracts the relevant device state (for example based on the nth bit based and/or upon the machine ID bitmask). This device state is used to manage an associated device as being activated or deactivated. For example, a safety relay can be used to enables or disable power to the device.

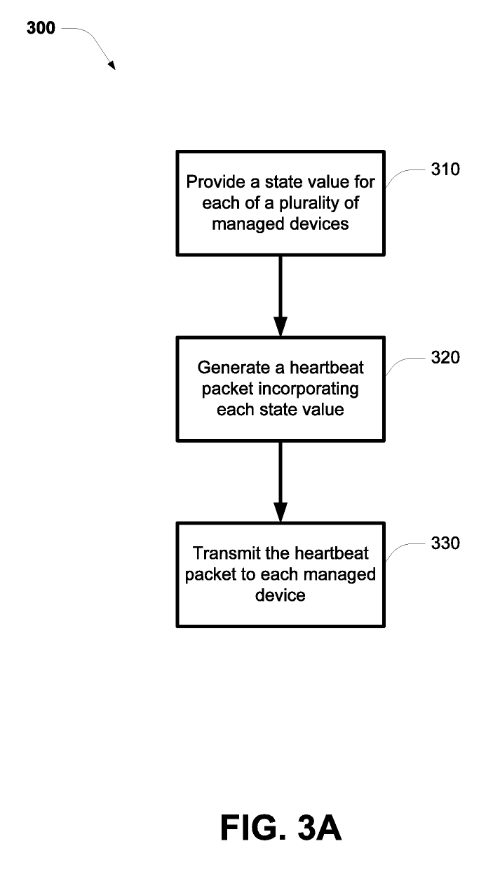

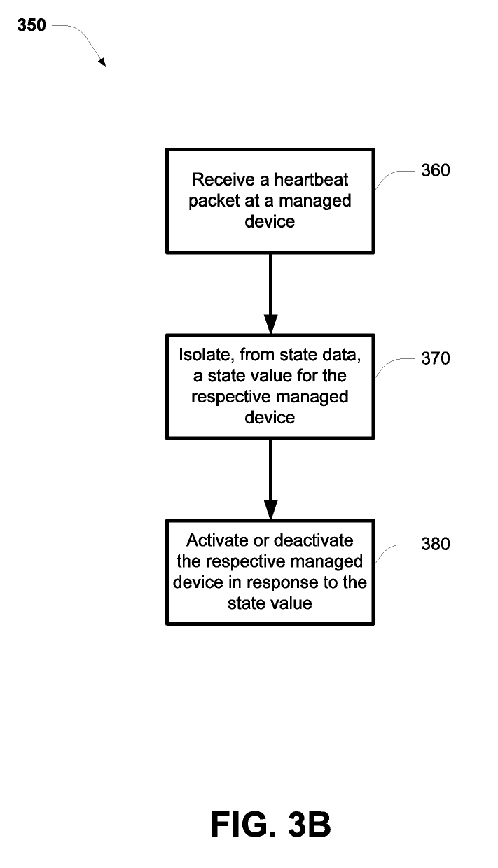

FIG. 3A shows an example flowchart of a method 300 of generating a heartbeat signal. This method of providing a bit masked heartbeat signal across a digital communication network to a plurality of managed devices comprises the steps of: (a) providing a state value 310 for each one of the managed devices; (b) generate a heartbeat packet 320 comprising state data that incorporates the state value of each one of the managed devices; and (c) transmitting the heartbeat packet 330 to each one of the managed devices.

In an embodiment, the state value can be binary, and the state data comprises at least one bit that is indicative of a respective state value for each of the managed devices. In this example, the bit mask can comprise a single bit for identifying a corresponding one of the managed devices.

In an alternative embodiment the state data can comprise a plurality of bits indicative of a respective state value for each of the managed devices. It will be appreciated that the state data can comprises a plurality of bits indicative of a collective state value for two or more of the managed devices. The state date can be generated using a bit mask applied across a plurality of bits.

FIG. 3B shows an example flowchart of a method 350 of decoding a heartbeat signal. This method of processing a bit masked heartbeat packet at a first managed device of a plurality of managed devices comprises the steps of: receiving the heartbeat packet 360 at the first managed device; isolating, from the state data, a respective state value 370 for the first managed device; and activating, or deactivating, the first managed device 380 in response to the respective state value.

It will be appreciated that, in the disclosed methods, the communication network can comprises a wireless communication network—including mesh and ad hoc wireless networks.

FIG. 4 shows an example data packet 400 for use with eight devices. This data packet comprises a header 410 (for synchronization and security), payload 420 incorporating n bits of state date indicative of the state value of each managed device, and a tail 430 (including checksum). In this example, devices 0,2,3,4 and 7 are identified as enabled, while devices 1,5 and 6 are identified as disabled. A microprocessor on a managed device would typically be adapted to disable power after a predetermined timeout period in which no valid heartbeat packet had been received.

In an embodiment, by way of example only, a device can include a receiver for receiving a heartbeat signal and a micro-controller that decodes the heartbeat signal. Using mesh or ad hoc wireless networks, the device can maintain contact in otherwise temporary RF blind spots—such as under bridges and behind hills. Preferably, a message structure can be defined in software, rather than in hardware.

According to an embodiment, a device can include an RF transceiver and a programmable logic controller (PLC). This PLC can receive a signal from an external agent (computer) via a suitable Field-bus (RS232, ProfiBus, Foundation or CAN). In this signal would be a message defining the various managed devices that are to be kept active (or alive). This message can be encrypted and transmitted over a suitable RF frequency (depending upon range and coverage). A plurality of receiver PLCs receive this signal. A SIM can be inserted into each PLC, where each SIM contains a corresponding encryption key and a designated index of the machine. The PLC can control a safety rated relay that is used to supply power to the managed device. The managed device would be powered (or activated) if, and only if, a specified heartbeat signal is received within a predetermined time period. The specified heartbeat signal comprises the correct encryption and a designated keep-alive (or activation) bit.

It will be appreciated that, this method has lower overheads than individually sending heartbeat signals to each managed device. This can include physical overheads in the case where separate transmitters and receivers are used, or communications overheads where the heartbeat signals have different addresses. In the later case, the reduction in communications overhead means that lower bandwidth communications infrastructure can be used, which in turn can enable use of lower frequencies and expand communication coverage of the system. Whilst an embodiment comprises customized hardware (RF circuits and PLC system), alternative embodiments can be implemented in software over WLAN network using UDP multicast, on embedded CPU based hardware.

A system can be based on conventional RF technology and a PLC. It will be appreciated that an error correction scheme can be applied to the heartbeat signal (e.g. CRC). Encryption can also be added to the heartbeat signal to avoid unintentional and/or malicious interference.

In an embodiment, a heartbeat signal can be transmitted on two substantially independent radio paths. As the propagation and failure mechanisms of each path are substantially (or preferably) independent, an improved reliability of the transmission can be achieved. By way of example only, an IEEE 802.11 based system and a UHF 27 MHz based system can be used to provide two substantially independent propagation paths for transmission of a heartbeat signal. The managed device can comprise two receivers and two decoding system and two safety rated relays. In this example, the relays are wired so that both must lose receipt of respective heartbeat signals for the device to be disabled. This method can reduce the likelihood of a managed device being disabled when a valid heartbeat is sent.

In an embodiment, a bit masked heartbeat signal (or message) can be transmitted across a communications network to a plurality of devices. These devices may include, or be incorporated into, machinery for the purpose of utilising heartbeat signal to implement a keep-alive safety protocol.

It will be appreciated that embodiments of the present invention can utilise wireless communication systems, including WLAN, WiFi, WiMax, 3G cellular, and ad-hoc wireless networks.

By way of example only, these methods can also be used for safety management of mining equipment at a mining site. The technology can be included in a new mining communication standard. It will be appreciated that the present invention is not limited to mining application and, by way of example, can also be used in air traffic control or naval traffic control.

### Interpretation

In the context of this document, the term “wireless” and its derivatives may be used to describe circuits, devices, systems, methods, techniques, communications channels, etc., that may communicate data through the use of modulated electromagnetic radiation through a non-solid medium. The term does not imply that the associated devices do not contain any wires, although in some embodiments they might not. In the context of this document, the term “wired” and its derivatives may be used to describe circuits, devices, systems, methods, techniques, communications channels, etc., that may communicate data through the use of modulated electromagnetic radiation through a solid medium. The term does not imply that the associated devices are coupled by electrically conductive wires.

Unless specifically stated otherwise, as apparent from the following discussions, it is appreciated that throughout the specification discussions utilizing terms such as “processing”, “computing”, “calculating”, “determining” or the like, refer to the action and/or processes of a computer or computing system, or similar electronic computing device, that manipulate and/or transform data represented as physical, such as electronic, quantities into other data similarly represented as physical quantities.

In a similar manner, the term “processor” may refer to any device or portion of a device that processes electronic data, e.g., from registers and/or memory to transform that electronic data into other electronic data that, e.g., may be stored in registers and/or memory. A “computer” or a “computing device” or a “computing machine” or a “computing platform” may include one or more processors.

The methodologies described herein are, in one embodiment, performable by one or more processors that accept computer-readable (also called machine-readable) code containing a set of instructions that when executed by one or more of the processors carry out at least one of the methods described herein. Any processor capable of executing a set of instructions (sequential or otherwise) that specify actions to be taken are included. Thus, one example is a typical processing system that includes one or more processors. The processing system further may include a memory subsystem including main RAM and/or a static RAM, and/or ROM.

Furthermore, a computer-readable carrier medium may form, or be included in a computer program product.

In alternative embodiments, the one or more processors operate as a standalone device or may be connected, e.g., networked to other processor(s), in a networked deployment, the one or more processors may operate in the capacity of a server or a client machine in server-client network environment, or as a peer machine in a peer-to-peer or distributed network environment. The one or more processors may form a web appliance, a network router, switch or bridge, or any machine capable of executing a set of instructions (sequential or otherwise) that specify actions to be taken by that machine.

Note that while some diagram(s) only show(s) a single processor and a single memory that carries the computer-readable code, those in the art will understand that many of the components described above are included, but not explicitly shown or described in order not to obscure the inventive aspect. For example, while only a single machine is illustrated, the term “machine” shall also be taken to include any collection of machines that individually or jointly execute a set (or multiple sets) of instructions to perform any one or more of the methodologies discussed herein.

Thus, one embodiment of each of the methods described herein is in the form of a computer-readable carrier medium carrying a set of instructions, e.g., a computer program that are for execution on one or more processors. Thus, as will be appreciated by those skilled in the art, embodiments of the present invention may be embodied as a method, an apparatus such as a special purpose apparatus, an apparatus such as a data processing system, or a computer-readable carrier medium. The computer-readable carrier medium carries computer readable code including a set of instructions that when executed on one or more processors cause a processor or processors to implement a method. Accordingly, aspects of the present invention may take the form of a method, an entirely hardware embodiment, an entirely software embodiment or an embodiment combining software and hardware aspects. Furthermore, the present invention may take the form of carrier medium (e.g., a computer program product on a computer-readable storage medium) carrying computer-readable program code embodied in the medium.

The software may further be transmitted or received over a network via a network interface device. While the carrier medium is shown in an example embodiment to be a single medium, the term “carrier medium” should be taken to include a single medium or multiple media (e.g., a centralized or distributed database, and/or associated caches and servers) that store the one or more sets of instructions. The term “carrier medium” shall also be taken to include any medium that is capable of storing, encoding or carrying a set of instructions for execution by one or more of the processors and that cause the one or more processors to perform any one or more of the methodologies of the present invention. A carrier medium may take many forms, including but not limited to, non-volatile media, volatile media, and transmission media.

It will be understood that the steps of methods discussed are performed in one embodiment by an appropriate processor (or processors) of a processing (i.e., computer) system executing instructions (computer-readable code) stored in storage. It will also be understood that the invention is not limited to any particular implementation or programming technique and that the invention may be implemented using any appropriate techniques for implementing the functionality described herein. The invention is not limited to any particular programming language or operating system.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

Similarly it should be appreciated that in the above description of example embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

Furthermore, some of the embodiments are described herein as a method or combination of elements of a method that can be implemented by a processor of a computer system or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element for the purpose of carrying out the invention.

In the description provided herein, numerous specific details are set forth. However, it is understood that embodiments of the invention may be practiced without these specific details. In other instances, well-known methods, structures and techniques have not been shown in detail in order not to obscure an understanding of this description.

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

In the claims below and the description herein, any one of the terms comprises, comprising, comprised of or which comprises is an open term that means including at least the elements/features that follow, but not excluding others. Thus, the term comprising, when used in the claims, should not be interpreted as being limitative to the means or elements or steps listed thereafter. For example, the scope of the expression a device comprising A and B should not be limited to devices consisting only of elements A and B. Any one of the terms including or which includes or that includes as used herein is also an open term that also means including at least the elements/features that follow the term, but not excluding others. Thus, including is synonymous with and means comprising.

Similarly, it is to be noticed that the term coupled, when used in the claims, should not be interpreted as being limitative to direct connections only. The terms “coupled” and “connected”, along with their derivatives, may be used. It should be understood that these terms are not intended as synonyms for each other. Thus, the scope of the expression a device A coupled to a device B should not be limited to devices or systems wherein an output of device A is directly connected to an input of device B. It means that there exists a path between an output of A and an input of B which may be a path including other devices or means. “Coupled” may mean that two or more elements are either in direct physical or electrical contact, or that two or more elements are not in direct contact with each other but yet still co-operate or interact with each other.

Thus, while there has been described what are believed to be the preferred embodiments of the invention, those skilled in the art will recognize that other and further modifications may be made thereto without departing from the spirit of the invention, and it is intended to claim all such changes and modifications as fall within the scope of the invention.

Although the invention has been described with reference to specific examples, it will be appreciated by those skilled in the art that the invention may be embodied in many other forms.

1. A method of providing a bit masked heartbeat signal across a digital communication network to a plurality of managed devices, said method comprising the steps of
(a) providing a state value for each one of said managed devices;
(b) generating a heartbeat packet comprising state data that incorporates said state value of each one of said managed devices; and
(c) transmitting said heartbeat packet to each one of said managed devices.

2. A method according to claim 1 wherein said state value is binary and said state data comprises one bit that is indicative of a respective state value for each one of said managed devices.

3. A method according to claim 1 wherein said state data comprises a plurality of bits indicative of a respective state value for each one of said managed devices.

4. A method according to claim 1 wherein said state data comprises a plurality of bits indicative of a collective state value for two or more of said managed devices.

5. A method according to claim 1, wherein said communication network comprises a wireless communication network.

6. A method according to claim 1, further comprising the steps of:
(d) receiving said heartbeat packet at a first of said managed devices;
(e) isolating, from said state data, a respective state value for said first managed device; and
(f) activating, or deactivating, said first managed device in response to said respective state value.

7. A method according to claim 1, wherein isolating said state value includes applying a bit mask across a plurality of said state data bits.

8. A method of processing a bit masked heartbeat packet at a first managed device of a plurality of managed devices, said method comprising the steps of
(a) receiving said heartbeat packet at said first managed device;
(b) isolating, from said state data, a respective state value for said first managed device; and
(c) activating, or deactivating, said first managed device in response to said respective state value.

9. A method according to claim 1, when used for air traffic control or naval traffic control.

10. A method according to claim 1, when used for safety management of mining equipment at a mining site.

11. (canceled)

12. A device for providing a bit masked heartbeat signal across a digital communication network, said device comprising a processor element coupled to a transmitter, said processor element being adapted for performing a method according to claim 1.

13. A device for providing a bit masked heartbeat signal across a digital communication network, said device comprising:
a transmitter for transmitting said heartbeat signal;
a processor element coupled to said transmitter; said processor adapted to perform the method according to claim 1.

14. A device for processing a bit masked heartbeat packet at a first managed device of a plurality of managed devices, said device comprising:
a receiver for receiving said heartbeat packet via a digital communication network;
a processor element coupled to said receiver; said processor adapted to perform the steps of
(a) receiving said heartbeat packet at said first managed device;
(b) isolating, from said state data, a respective state value for said first managed device; and
(c) activating, or deactivating, said first managed device in response to said respective state value.

15. A device according to claim 13, when used for air traffic control or naval traffic control.

16. A device according to claim 13, when used for safety management of mining equipment at a mining site,

17-18. (canceled)

19. A computer-readable carrier medium carrying a set of instructions that when executed by one or more processor elements cause the one or more processor elements to carry out a method of according to claim 1.

20. (canceled)

21. A method according to claim 8, when used for air traffic control or naval traffic control.

22. A method according to claim 8, when used for safety management of mining equipment at a mining site.

23. A device according to claim 14, when used for air traffic control or naval traffic control.

24. A device according to claim 14, when used for safety management of mining equipment at a mining site.
